(19) United States
(12) Patent Application Publication
(10) Pub. No.: US 2018/0157647 A1
(43) Pub. Date: Jun. 7, 2018

(54) Methods and Systems for Processing Translations Based on a Social Media Profile

(71) Applicant: FACEBOOK, INC., Menlo Park, CA (US)

(72) Inventors: Niharika Marwah, Redwood City, CA (US); Russell William James Porter, Redwood City, CA (US); Maria Pruzan, Mountain View, CA (US)

(21) Appl. No.: 15/372,303

(22) Filed: Dec. 7, 2016

(51) Int. Cl. G06F 17/28; H04L 12/58

(52) U.S. Cl. CPC G06F 17/289; H04L 51/32; G06F 17/2854

(57) ABSTRACT

Methods, systems, and/or devices for processing translations are described. In some embodiments, the method may comprise receiving a request to display a message to a user and determining a language in which to display the message, where the language has multiple translations for the message based on a condition associated with the user. In some embodiments, it comprises determining a value for the condition, selecting a translation from the multiple translations based, at least in part, on the value, and displaying the selected translation to the user.

### TECHNICAL FIELD

The disclosed implementations relate generally to translating between languages, and, in particular, to determining translations based on a condition.

### BACKGROUND

While interpreting—the facilitating of oral or sign-language communication between users of different language—antedates writing, translation began after the appearance of written literature.

Since at least that time, people have worked to translate communications made in one language so that they can be understood by those who understand a different language. For example, the English phrase “hello world” would be written as “hola mundo” in Spanish, “bonjour le monde” in French, “ [symbol] ” in Hebrew, and “ [symbol] ” in Japanese.

Interactive services, such as social media services, allow users to interact with the services and potentially other users of the services. Sometimes, these users speak different languages and translation must be done between them. Historically, this was done either by having a human who understood both languages, or more recently, using an automated service, such as Google Translate or Bing's Bablefish. While effective, these services have limitations in languages where the translation depends on the speaker and/or the recipient. For example, the English word “you” may translate into either of the French words “tu” or “vous,” depending on the relationship of the parties. In other words, an additional condition (in this case, familiarity) is required to give a proper translation.

While the difference between using “tu” or “vous” in French may be viewed as a mere politeness, certain languages have different words for “you” based on the sex or gender of the speaker or recipient. For example, Hebrew has two versions of “you,” based on the gender of the person to whom “you” is referring. As another example, in some forms of Hebrew, “ [symbol] ” means a male “you” and “ [symbol] ” means a female you. In such languages, failure to properly translate “you” may result in inadvertently labeling someone a different sex or gender.

As computers became popular in the 1980's, computer programs were created which would “talk” to the user by displaying messages ranging from instructions to responses. As computers became more widespread outside of the English-speaking world, the need for computers to speak to people in multiple languages became increasingly important. Initially, programmers would write multiple versions of software for languages such as Spanish, French, or Japanese, but as both the number of messages software needed to display and the number of languages in which the messages needed to be displayed grew, such methods resulted in unnecessary work. Accordingly, translation files were created such that a message could be loaded based on an index.

However, while index files solved the generic program of displaying messages in an appropriate language without having to create and recompile separate versions of a software program, they could not solve problems such as which word to use when a translation varied based on the recipient's gender.

Client-server applications have grown in increasingly popular. Unlike a traditional software “program” running on a computer (e.g., a PC), a client-server program may consist of a server program that “talks” to numerous clients whose users may speak multiple languages. Accordingly, the client applications often need to translate the messages sent by the server into an appropriate language. Further, because the server may communicate with multiple users on multiple clients (and may not be aware of who the users are), the clients may need to translate the messages based on characteristics (e.g., gender) of the users in a manner that isolates the server from needing to be aware of the users' characteristics.

### SUMMARY

Accordingly, there is a need for a method and system to translate phrases using context. Further, there is a need for a system to translate messages taking into account qualities (e.g., gender) about the recipient.

In accordance with some embodiments, a method is performed at a client device with one or more processors and memory storing instructions for execution by the one or more processors. The method includes receiving a request to display a message to a user. The method further comprises determining a language in which to display the message, where the language has multiple translations for the message based on a condition associated with the user. The method further comprises determining a value for the condition and selecting a translation from the multiple translations based, at least in part, on the value. The method comprises displaying the selected translation to the user.

In accordance with some implementations, a server system includes one or more processors and memory storing one or more programs configured to be executed by the one or more processors. In some embodiments, the client will interact with the server. The one or more programs include instructions for performing the operations of the method described above. In accordance with some implementations, a non-transitory computer-readable storage medium has stored therein instructions that, when executed by the server system, cause the presentation device to perform the operations of the method described above.

Thus, client users are provided with accurate and context-sensitive translations of messages.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings and specification.

FIG. 1 is a block diagram illustrating an exemplary network architecture in accordance with some implementations.

FIG. 2 is a block diagram illustrating an exemplary client in accordance with some implementations.

FIG. 3 is a block diagram illustrating an exemplary server system in accordance with some implementations.

FIG. 4 illustrates an exemplary mapping of a message in one language to a phrase in another language, based on a condition.

FIGS. 5A-5C illustrate a flow diagram illustrating a method of translating a message based on a condition associated with the recipient.

### DETAILED DESCRIPTION

Reference will now be made to implementations, examples of which are illustrated in the accompanying drawings. In the following description, numerous specific details are set forth in order to provide an understanding of the various described implementations. However, it will be apparent to one of ordinary skill in the art that the various described implementations may be practiced without these specific details. In other instances, well-known methods, procedures, components, circuits, and networks have not been described in detail so as not to obscure aspects of the implementations unnecessarily.

It will also be understood that, although the terms first, second, etc. are, in some instances, used herein to describe various elements, these elements should not be limited by these terms. These terms are used only to distinguish one element from another.

The terminology used in the description of the various implementations described herein is for the purpose of describing particular implementations only and is not intended to be limiting. As used in the description of the various described implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “exemplary” is used in the sense of “serving as an example, instance, or illustration” and not in the sense of “representing the best of its kind.”

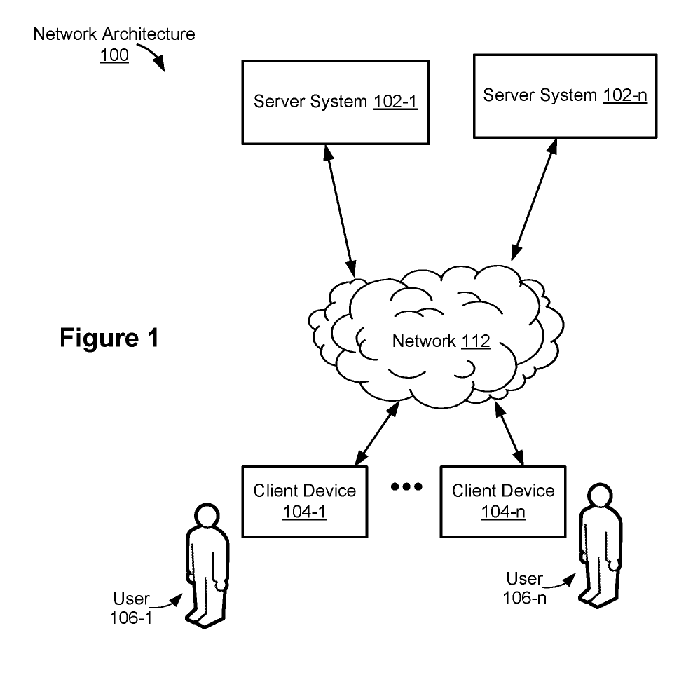

FIG. 1 is a block diagram illustrating an exemplary network architecture 100 in accordance with some implementations. The network architecture 100 includes one or more clients 104-1 . . . 104-n (where n is an integer greater than or equal to one) and one or more server systems 102. One or more networks 112 communicably connect each component of the network architecture 100 with other components of the network architecture 100. In some implementations, the one or more networks 112 include public communication networks, private communication networks, or a combination of both public and private communication networks. For example, the one or more networks 112 can be any network (or combination of networks) such as the Internet, other wide area networks (WAN), local area networks (LAN), virtual private networks (VPN), metropolitan area networks (MAN), peer-to-peer networks, and/or ad-hoc connections.

A client 104 (e.g. 104-1, 104-2, . . . 104-n) is associated with one or more users 106 (e.g., 106-1, 106-2, . . . 106-n). In some implementations, a client 104 is a personal computer, a mobile electronic device, a wearable computing device, a laptop, a tablet computer, a mobile phone, a feature phone, a smart phone, a digital media player, or any other device capable of capturing and/or transmitting data. In some implementations, clients 104 include input devices 208 for receiving user inputs (e.g., keyboards or mice for receiving a first version and a second version of an API and/or an application name, which the clients may store and/or transmit to other components of the network architecture 100, such as the server system 102). Clients 104 may be the same type of device (e.g., all mobile devices), or may comprise different types of devices.

Users 106 employ clients 104 to execute functions, such as functions related to social media systems. In some embodiments, functions may be executed entirely on the clients 104. In some such embodiments, the client 104 may not be connected to a network 112 or may be disconnected from the network 112 temporarily.

In some embodiments, the clients 104 will send a function request to a server system 102, which will perform the requested function and the client will display the result. For example, the request may ask the server to return an message. The clients 104 may access the server systems 102 through various means via network 112. For example, in some embodiments, a client 104 executes a web browser application that can be used to access a social media service hosted by the server system 102. For another example, in some embodiments, the client 104 may execute a software application that is specific to the social media service (e.g., an “app” running on a smart phone, tablet, or other device).

In some embodiments, the server system 102 stores and provides content (via the network(s) 112) to the users 106 via the client 104. Content stored and served by the server system 102, in some implementations, includes lists of functions, user data, and content necessary to perform the functions. For example, for a function to display a list of possible conversation starts, the server may store potential ways to start a conversation.

The description of the server system 102 as a “server” is intended as a functional description of the devices, systems, processors, and/or other components that provide the functionality attributed to the server system 102. It will be understood that the server system 102 may be a single server computer or multiple server computers. The server system 102 may be coupled to other servers and/or server systems, or other devices, such as other user devices, databases, content delivery networks (e.g., peer-to-peer networks), network caches, and the like. In some embodiments, the server 102 may communicate with other, unaffiliated, servers. In some implementations, the server system 102 is implemented by multiple computing devices working together to perform the actions of a server system (e.g., cloud computing). Furthermore, any functionalities performed by the server system 102 may also be performed additionally, alternatively, and/or concurrently by the one or more clients 104. For example, some keyword functions may be fully executable on a client device 104 without the need to communicate with a server 102.

Clients 104 and the server system 102 may be communicably coupled in a variety of ways. In some implementations, multiple clients 104 send requests to perform various functions to a server system 102 via a network 112. In response to receiving the requests, the server system 102 may return the requested information to the client 104.

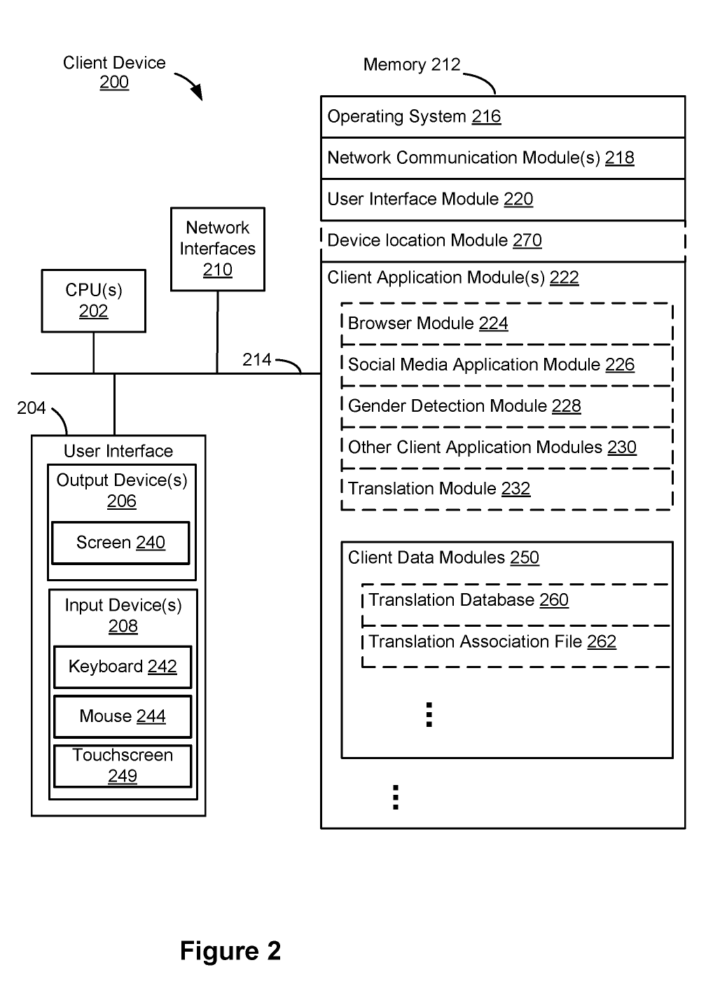

FIG. 2 is a block diagram illustrating an exemplary client 200 (e.g., 104-1 . . . 104-n, FIG. 1) in accordance with some implementations. The client 200 typically includes one or more central processing units (CPU(s), e.g., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

As also shown in FIG. 2, the client 200 typically includes a user interface 204, including output device(s) 206 and input device(s) 208. In some embodiments, output devices 206 comprise a screen 240 or speakers. In some implementations, the input devices 208 include one or more of a keyboard 242, mouse 244, or touchscreen 249. Alternatively, or in addition, the user interface 240 may include a display device that may include a touch-sensitive surface, in which case the screen 240 may also comprise a touch-sensitive display 249 (e.g., a “touchscreen”). In user devices that have a touch-sensitive display 249, a physical keyboard is optional (e.g., a soft keyboard may be displayed when keyboard entry is needed). Furthermore, some user devices 102 may use a microphone and a voice recognition device to supplement or replace the keyboard 242.

In some implementations, the one or more network interfaces 210 include wireless and/or wired interfaces for receiving data from and/or transmitting data to a server system 102 and/or other devices or systems. In some implementations, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some implementations, data communications are carried out using any of a variety of custom or standard wired protocols (e.g., USB, Firewire, Ethernet, etc.). For example, in some implementations, the one or more network interfaces 210 includes a wireless LAN (WLAN) interface for enabling data communications with the server system 104 (via the one or more network(s) 112, FIG. 1).

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some implementations, memory 212 or the non-transitory computer-readable storage medium of memory 212 stores the following programs, modules, and data structures, or a subset or superset thereof:
an operating system 216 that includes procedures for handling various basic system services and for performing hardware dependent tasks;
a device location module 270 for determining the location of the device;
network communication module(s) 218 for connecting the client 104 to other computing devices (e.g., server system 102) via the one or more network interface(s) 210 (wired or wireless);
a user interface module 220 that receives commands and/or inputs from a user 106 via the user interface 204 (e.g., from input devices 208), and provides outputs for display by the user interface 204 (e.g., the output devices 206); and
one or more client application modules 222, including the following modules (or sets of instructions), or a subset or superset thereof:
   a web browser module 224 (e.g., Internet Explorer or Edge by Microsoft, Firefox by Mozilla, Safari by Apple, or Chrome by Google) for accessing, viewing, and interacting with web sites (e.g., a social-networking web site provided by the server system 102),
   a social media application module 226 for allowing a user 106 to access a social media system;
   a gender detection module 228, to determine the likely gender of a user 106;
   a translation module 232 for translating messages into a language understood by user 106;
   one or more client data module(s) 250 for handling the storage of and access to content, including but not limited to:
      a translation database 260, capable of returning a translation for an inputted phrase and, optionally, one or more conditions; and
      a translation association file 262, for providing direct mapping of messages, languages, and/or conditions, into translations of the messages;
   other optional client application module(s) 230, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D gaming, virtual reality, electronic book reader, and/or workout support.

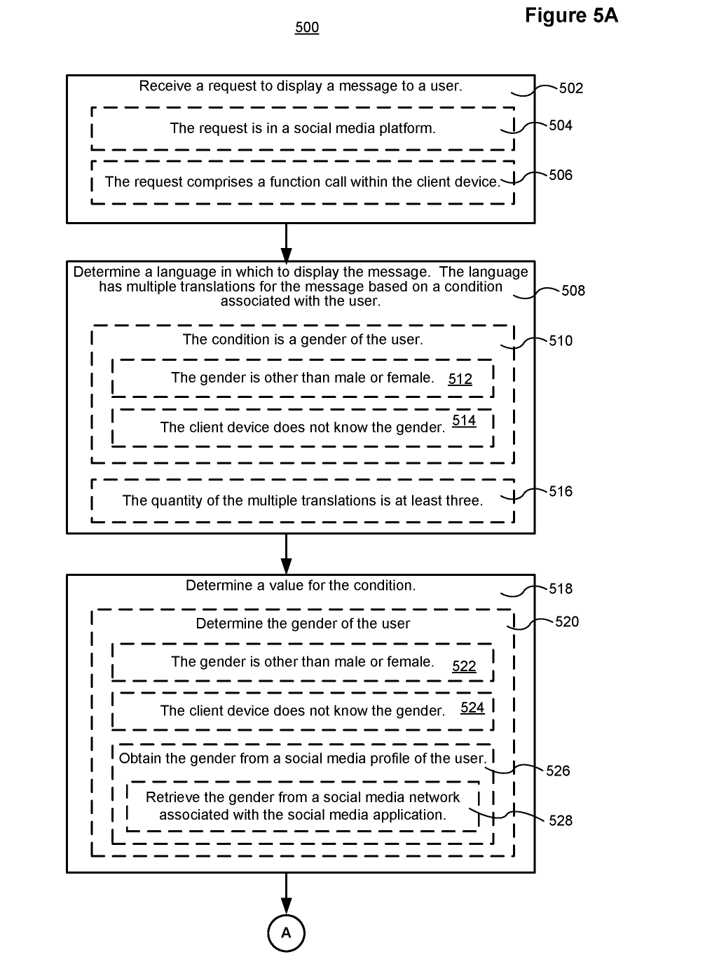

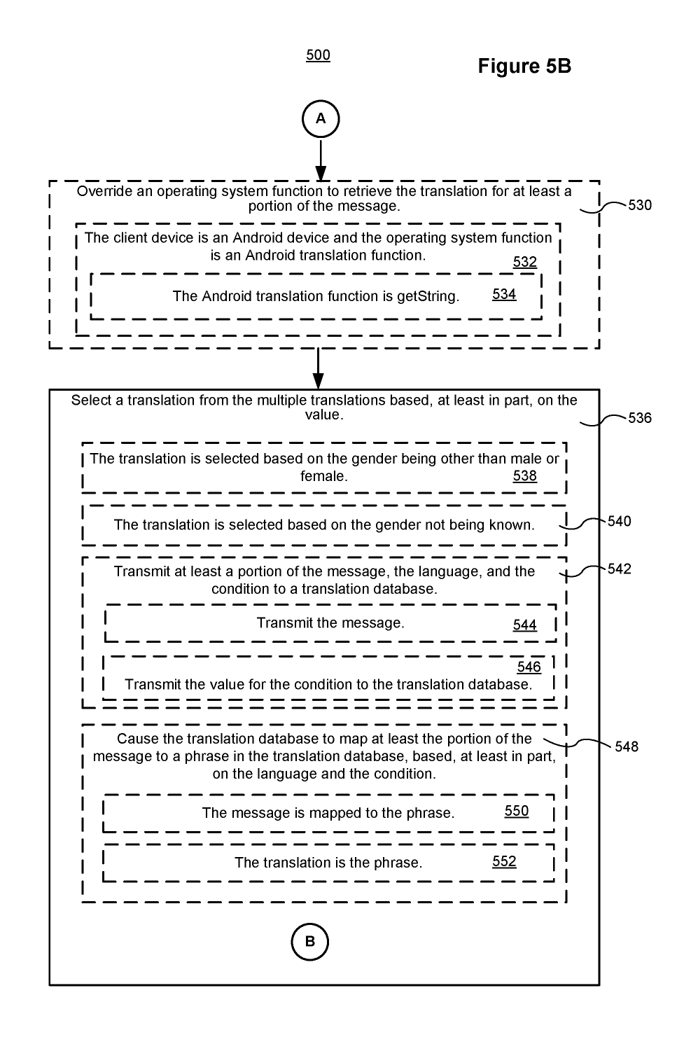

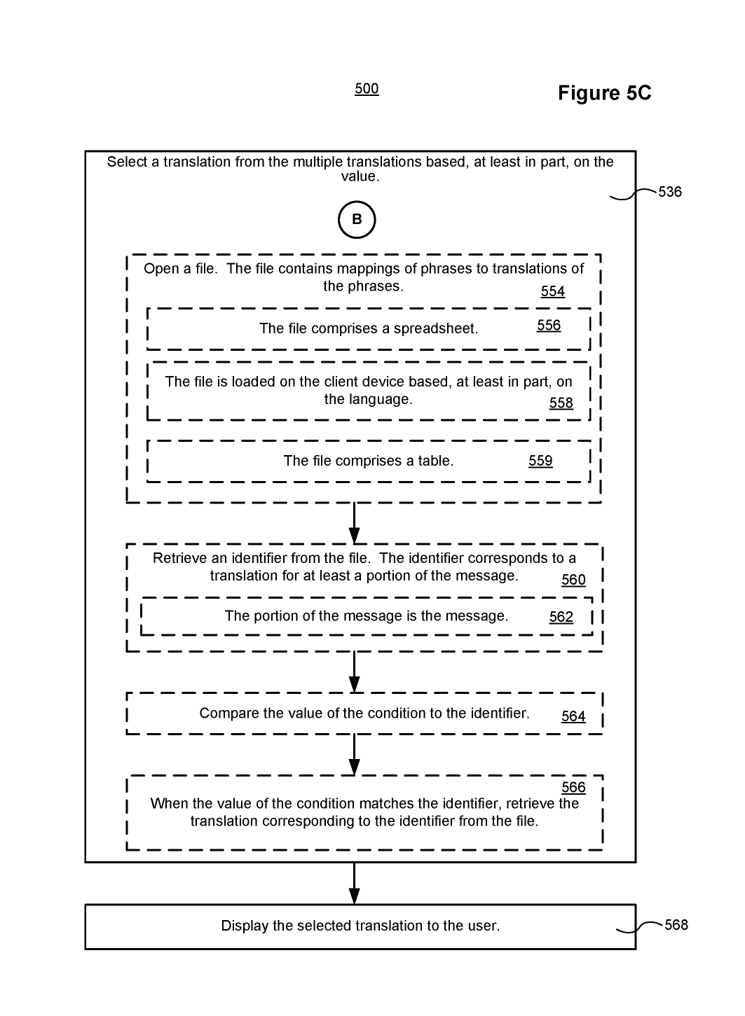

The optional device location module 270 functions to determine the location of the client device 200. This module may comprise network location services provided by a carrier (e.g., Sprint, Verizon, AT&T, or T-Mobile), satellite location services (e.g., the Global Positioning System (GPS), GLONASS, Galileo, and BeiDou), or WiFi Positioning Systems (WiPS), etc. In some implementations, multiple location services may be used. As discussed with respect to FIG. 5, below, in some embodiments, translation module 232 may use device location module 270 to determine the location of a client device 200, such as when a translation requires knowledge of a location and one is not specified by a user 106.

The optional translation module 232 provides functions for translating messages from a language not understood by user 106 into a language understood by the user. Translation module 232 provides translations of messages in cases where there is a 1:1 mapping between two languages (e.g., “hello world” in English to “bonjour le monde” in French). Where, there is a 1:n (e.g., 1:2) mapping of a phrase from one language into another, translation module 232 will use one more conditions to determine the correct translation. For example, “how are you” in English may translate into either “comment vas-tu” or “comment allez-vous” based on the condition of familiarity. To determine the appropriate translation, translation module 232 will map the message and the condition to the correct translation.

Translation database 260 stores and indexes messages, languages, and conditions for use by the various client modules, including social media application module 226. It may comprise one or more types of databases, such as text, graph, dimensional, flat, hierarchical, network, object-oriented, relational, distributed, and/or XML databases. In some embodiments, translation database 260 may be accessed publically. In other embodiments, translation database 260 may be accessed only by social media application module 226 and/or other client application modules 230.

Translation association file 262 stores and indexes messages, languages, and conditions for use by the various client modules, including social media application module 226. It may comprise one or more types of index files include spreadsheet (such as Excel), XML, or comma-separated. In some embodiments, translation association file 262 may be accessed publically. In other embodiments, translation association file 262 may be accessed only by social media application module 226 and/or other client application modules 230.

Although FIG. 2 illustrates the client 200 in accordance with some implementations, FIG. 2 is intended more as a functional description of the various features that may be present in one or more clients 200 than as a structural schematic of the implementations described herein. In practice, items shown separately could be combined and some items could be separated. For example, some items shown separately in FIG. 2 could be implemented in single applications and single items could be implemented by one or more applications. The actual number of applications used to implement the client 200, and how features are allocated among them, will vary from one implementation to another.

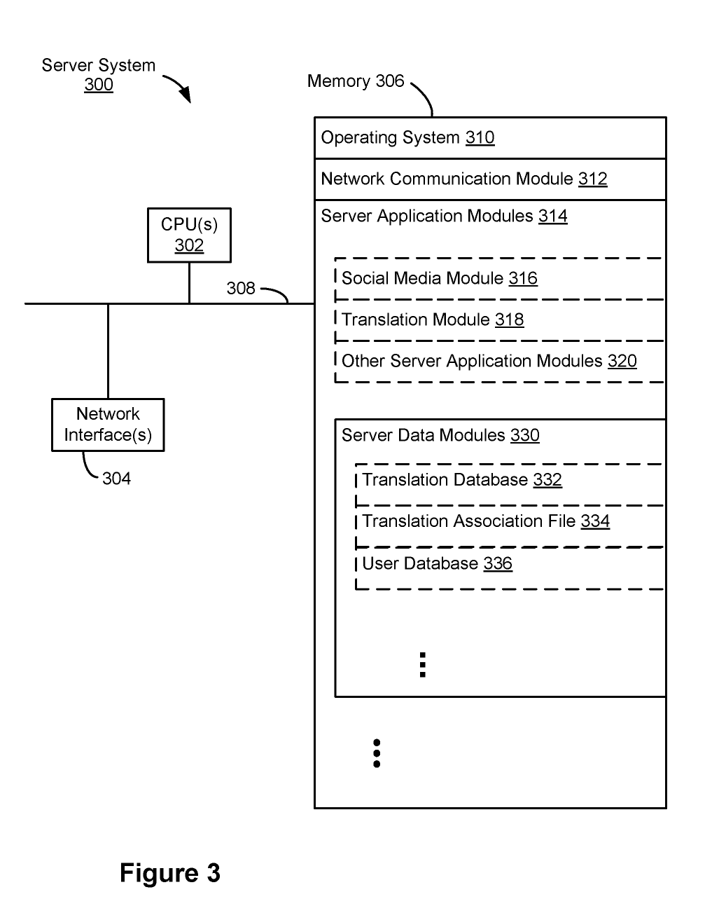

FIG. 3 is a block diagram illustrating an exemplary server system 300 (e.g., server 102-1, 102-n, FIG. 1) in accordance with some implementations. The server system 300 typically includes one or more central processing units/cores (CPUs) 302, one or more network interfaces 304, memory 306, and one or more communication buses 308 for interconnecting these components.

Memory 306 includes high-speed random access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306, optionally, includes one or more storage devices remotely located from one or more CPUs 302. Memory 306, or, alternatively, the non-volatile solid-state memory device(s) within memory 306, includes a non-transitory computer-readable storage medium. In some implementations, memory 306, or the non-transitory computer-readable storage medium of memory 306, stores the following programs, modules, and data structures, or a subset or superset thereof:
an operating system 310 that includes procedures for handling various basic system services and for performing hardware dependent tasks;
a network communication module 312 that is used for connecting the server system 300 to other computing devices (e.g., clients 200 (FIG. 2) or other server systems 300) via one or more network interfaces 304 (wired or wireless) connected to one or more networks 112 (FIG. 1) such as the Internet, other WANs, LANs, PANs, MANs, VPNs, peer-to-peer networks, content delivery networks, ad-hoc connections, and so on;
one or more server application modules 314 for enabling the server system 300 to perform various functions, the server application modules 314 including, but not limited to, one or more of:
   a social media module 316 for providing social media services and/or services to support social media services;
   a translation module 318, for translating messages from one language into another;
   one or more server data module(s) 330 for handling the storage of and access to content, including but not limited to:
      a user database 336, for storing user data;
      a translation database 332, capable of returning a translation for an inputted phrase and, optionally, one or more conditions; and
      a translation association file 334, for providing direct mapping of messages, languages, and/or conditions, into translations of the messages;

The optional translation module 318 provides functions for translating messages from one language into another language. Translation module 318 provides translations of messages in cases where there is a 1:1 mapping between two languages (e.g., “hello world” in English to “bonjour le monde” in French). Where, there is a 1:n (e.g., 1:2) mapping of a phrase from one language into another, translation module 232 will use one more conditions to determine the correct translation. For example, “how are you” in English may translate into either “comment vas-tu” or “comment allez-vous” based on the condition of familiarity. To determine the appropriate translation, translation module 318 will map the message and the condition to the correct translation. In some embodiments, translation module 318 provides results of translations to clients 200 (FIG. 2).

Translation database 332 stores and indexes messages, languages, and conditions for use by the various client modules, including social media application module 226 (FIG. 2) and social media module 316. It may comprise one or more types of databases, such as text, graph, dimensional, flat, hierarchical, network, object-oriented, relational, distributed, and/or XML databases. In some embodiments, translation database 332 may be accessed publically. In other embodiments, translation database 332 may be accessed only by social media application module 226 (FIG. 2), social media module 316, and/or other server application modules 320.

Translation association file 334 stores and indexes messages, languages, and conditions for use by the various client modules, including social media application module 226 (FIG. 2) and social media module 316. It may comprise one or more types of index files include spreadsheet (such as Excel), XML, or comma-separated. In some embodiments, translation association file 334 may be accessed publically. In other embodiments, translation association file 334 may be accessed only by social media application module 226 (FIG. 2), social media module 316, and/or other server application modules 320.

User database 336 stores data pertaining to a user 106. This information may include gender, gender preference, title, status, race, age, and other demographic information. In certain languages, one or more of these characteristics may impact a translation. For example, in some languages, the gender of the user 106 will result in a different translation of certain words or phrases. In other languages, the title or status of the user 106 may result in a different translation of those (or other) words or phrases.

The descriptions of translation database 332, translation association file 334 generally apply to translation database 260 and translation association file 262 (FIG. 2) and vice-versa.

In some implementations, the server system 300 includes web or Hypertext Transfer Protocol (HTTP) servers, File Transfer Protocol (FTP) servers, as well as web pages and applications implemented using Common Gateway Interface (CGI) script, PHP Hypertext Preprocessor (PHP), Active Server Pages (ASP), Hyper Text Markup Language (HTML), Python, Extensible Markup Language (XML), Java, JavaScript, Asynchronous JavaScript and XML (AJAX), XHP, Javelin, Wireless Universal Resource File (WURFL), and the like.

Although FIG. 3 illustrates the server system 300 in accordance with some implementations, FIG. 3 is intended more as a functional description of the various features that may be present in one or more server systems than as a structural schematic of the implementations described herein. In practice, items shown separately could be combined and some items could be separated. For example, some items shown separately in FIG. 3 could be implemented on single servers and single items could be implemented by one or more servers. The actual number of servers used to implement the server system 300, and how features are allocated among them, will vary from one implementation to another and, optionally, depends in part on the amount of data traffic that the server system handles during peak usage periods as well as during average usage periods.

Each of the above identified modules stored in memory 212 and 306 corresponds to a set of instructions for performing a function described herein. The above identified modules or programs (i.e., sets of instructions) need not be implemented as separate software programs, procedures, or modules, and thus various subsets of these modules may be combined or otherwise re-arranged in various implementations. In some implementations, memory 212 and 306 optionally store a subset or superset of the respective modules and data structures identified above. Furthermore, memory 212 and 306 optionally store additional modules and data structures not described above.

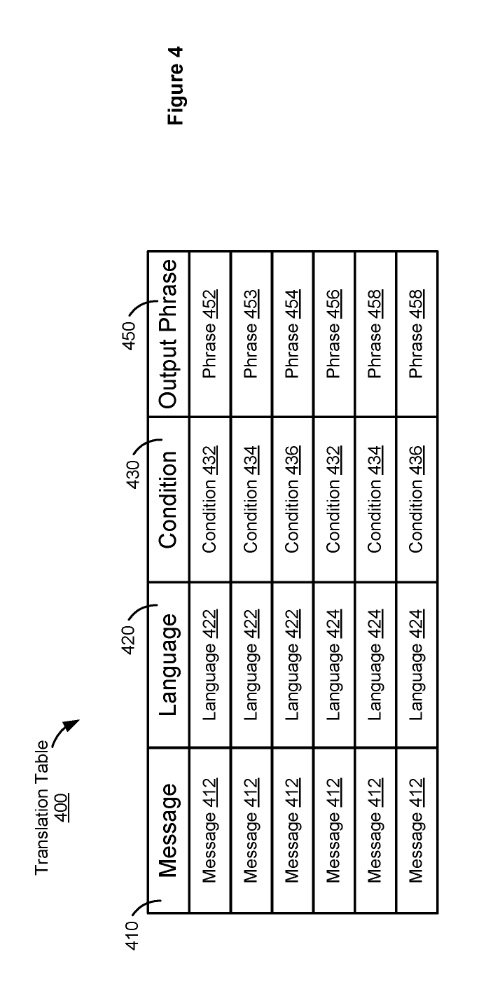

FIG. 4 illustrates an exemplary translation table 400 mapping messages 410 in a first language to a phrase 450 in second language 420 based on a condition 430. In this exemplary table, there is an input message 410 and Message 412. The table contains mappings into two languages 420, Language 422 and Language 424. Exemplary translation table 400 contains three conditions 430, which impact Language 422 and Language 424. These conditions 430 are Condition 432, Condition 434, and Condition 436. For example, string 412 maps to the output phrase 450 of phrase 452 in the language 422 when the condition 430 is condition 432. For another example, if condition 430 is condition 434, for the same language 420, string 412 would map to phrase 453.

For another example, where the condition 430 is the gender of the recipient, values for the conditions 432, 434, and 436 may be male, female, and unknown, respectively. Accordingly, message 412 translated into language 422 will result in different translations based on the recipient's gender. Further, in some embodiments, where client 200 is unaware of the gender, a third translation will be used. Translation module 232 or social media application module 226 may then display different messages to a user 106 of client device 200 based on the determination of user 106's gender (or lack of knowledge thereof).

Exemplary language 424 differs from language 422 in that it has only two potential phrases based on a condition. To use the gender example above, “unknown” genders may be treated in language 424 as being female. Accordingly, following the example above, message 412 maps to phrase 456 for male and 458 for female, but message 412 also maps to 458 when the gender of user 106 is unknown. For example, in the language 420 of Hebrew, the (English) message 410 “What are you doing?” maps to different output phrases 450 based on the condition 430 of gender. For example, “What are you doing?” maps to “ [symbol] ?” if the gender condition of user 106 is male and “ [symbol] ?” if the gender condition of user 106 is female. In traditional Hebrew, if the gender of user 106 is not known, the phrase will map to “ [symbol] ?” (i.e., male).

Those skilled in the art will recognize that the number of conditions can vary based on language. Using gender as an example, an exemplary language may have different translations based on whether the user 106 is male, female, other, or unknown. To continue with the gender example, other exemplary languages may have only two conditions (e.g., male and female) with “unknown” or “other” being treated as male and female.

While gender has been used as an example, those skilled in the art will recognize that other criteria regarding the user 106 may include title, status, race, national origin, age, familiarity, marital status, or other criteria. In some embodiments, multiple conditions may be used and are included in the scope of the invention. For example, for an exemplary language, the English word “you” may translate into different words based on both the gender and the status of the user 106. For another example, in an exemplary language, the English word “you” may translate into different words based on the marital status of a user, but only if the gender of the user is of a certain subset of genders.

FIG. 5 is a flow diagram illustrating a method 500 of translating a message into another language based on a condition.

The steps of the method 500 may be performed by any combination of one or more clients 104 (FIGS. 1 and 2) and/or server system 102 (FIGS. 1 and 3). FIG. 5 corresponds to instructions stored in computer memory (e.g., memory 212 of the client 104, FIG. 2; memory 306 of the server system 102, FIG. 3; or other computer-readable storage medium. In some embodiments, method 500 may be performed entirely on a client 104.

In some embodiments, in performing the method 500, in step 502, a client 200 (FIG. 2) receives a request to display a message to a user 106 (FIG. 1). In some embodiments, the request may be in a social media platform (504). In some embodiments, the request comprises a function call within the client 200 (506).

In some embodiments, the client 200 will determine (508) a language in which to display the message. The language 420 (FIG. 4) may have multiple translations for the message based on a condition 430 (FIG. 4). In some embodiments, the condition will be associated with user 106. In some embodiments, the condition is a gender of the user (510). For example, in Hebrew, the English word “you” translates to “ [symbol] ” if the recipient is male and “ [symbol] ” if the recipient is female. Sometimes, the gender may be other (512) than male or female. For example, other genders may include asexual, androgyne, androgynous, bigender, neutral, intersex person, hermaphrodite, polygender, and others.

In some embodiments, gender detection module 228 (FIG. 2) on client 200 may attempt to determine an appropriate gender. But, in some embodiments, the client 200 may not know (514) the gender of user 106. For example, the user may be unknown. For another example, client 200 may have identified user 106, but gender detection module 228 does not have access to data concerning user 106's gender. This can occur, for example, where a user 106 has not specified a gender in social media application module 226, or the information is not stored in user database 336 (FIG. 3), or the information is configured such as to not be accessible by social media application module 226 or client 200. In some exemplary languages, translation module 232 may provide the translated message in a neutral or neuter form. In some exemplary languages, such as traditional Hebrew, translation module 232 may provide the translated message in masculine form.

In some embodiments, the quantity of the multiple translations is at least three (516). For example, as described previously with respect to step 512, an exemplary language may have different translations for the English word “you” based on the gender of user 106 being determined to be male, female, neutral, asexual, hermaphrodite, polygender, or other. For another example, an exemplary language may have different translations for the English word “you” based on the status of a user 106 being king, squire, duke, count, knight, other noble, or commoner. In both of these examples, the exemplary languages may have yet another translation where the gender and/or status of the user 106 is unknown by the speaker.

In some embodiments, the method 500 will determine (518) a value for the condition. In some embodiments, the client 200 will determine (520) the gender of the user. For example, gender detection module 228 (FIG. 2) may determine the gender of the user based on configurations on client 200, such as settings in operating system 216 or social media application module 226. For another example, gender detection module 228 or social media application module 226 may query user database 336 (FIG. 3) to obtain user 106's gender. In some embodiments, client 200 may obtain (526) the gender from a social media profile of user 106. In some embodiments, client 200 will retrieve (528) the gender from a social media network associated with the social media application 226. For example, this may be done by querying social media module 316 (FIG. 3).

In some embodiments, the gender is other (522) than male or female. For example, the gender could be polygender, asexual, androgyne, androgynous, bigender, neutral, intersex person, hermaphrodite, etc. Similarly, as discussed previously, sometimes the client 200 does not know (524) the gender. When client 200 does not know the gender and gender detection module 228 is unable to determine it, as discussed previously with respect to step 514, translation module 232 will apply rules consistent with the exemplary language to create the translation.

In some embodiments, the client 200 overrides (530) an operating system function to retrieve the translation for at least a portion of the message. For example, an operating system may have a function to return a string in a given language, but the string will not be based on a condition. For an English example, a call may result in a string such as “he/she,” when a more precise string would be either “he” or “she” based on the gender of the person being referred to. In some languages, such as Hebrew, “you” may be written differently based on the gender of the recipient. To avoid having the operating system return two options, the operating system call will be overridden to connect into a translation engine, such as translation module 232 (FIG. 2) to have the condition (e.g., gender) evaluated to create a string that takes the condition into account. In some embodiments, the translation module may be associated with a social media application such as social media application module 226. In some embodiments, the translation module 232 will use data contained in translation database 260 or translation association file 262 to return the translation. Sometimes, the client is an Android device (532), and the operating system function is an Android translation function. For example, client 200 may be an Android smartphone, such as a Samsung Galaxy S6 smartphone. For another example, client 200 may be an Android tablet, such as a Sony Xperia Z4 tablet. In some embodiments, the Android translation function is getString (534). In some embodiments, other functions may be overridden. In some embodiments, multiple functions may be overridden.

In some embodiments, method 500 selects (536) a translation from the multiple translations based, at least in part, on the value. As discussed previously with respect to step 512, sometimes, the translation is selected (538) based on the gender of user 106 being other than male or female. Similarly, as discussed previously with respect to step 514, sometimes the translation is selected (540) based on the gender not being known.

In some embodiments, the client 200 transmits (542) at least a portion of the message, the language, and the condition to a translation database, such as translation database 260 (FIG. 2) or translation database 332 (FIG. 3). For example, an exemplary message portion of “you,” an exemplary language of “French,” and an exemplary condition of “familiarity” may be transmitted to the translation database. Sometimes, the complete message is transmitted (544). For example, instead of just transmitting “you,” the message “What are you thinking?” may be transmitted. In some embodiments, the value for the condition (546) is transmitted to the translation database. For example, to use the condition of “familiarity,” “friend” or “formal” may be transmitted. For the condition of “gender,” “male” or “female” may be transmitted.

In some embodiments, the client 200 will cause the translation database, such as translation database 260 (FIG. 2) or translation database 332 (FIG. 3), to map (548) at least the portion of the message to a phrase in the translation database, based, at least in part, on the language and the condition. Sometimes, the message is mapped (550) to the phrase. For example, where the entire message was transmitted to the translation database, the database may map the entire message to the translated phrase. Similarly, sometimes the translation is the phrase (552).

In some embodiments, a file containing mappings of phrases to translations of the phrases is opened (554). Sometimes, the file comprises a table (559). Sometimes, the file comprises a spreadsheet (554). For example, the file may comprise a Microsoft Excel document or workbook. In some embodiments, the file may be a flat file, an XML file, a common-separated file, a mapping graph, or other types of files. In some embodiments, the file will be stored on client 200. In some embodiments, the file may be stored on a server 300. In some embodiments, the file is loaded (558) on the client device based, at least in part, on the language. In some embodiments, the file may be stored in memory 212 (FIG. 2). In some embodiments, only part of the file may be loaded.

In some embodiments, an identifier is retrieved (560) from the file. The identifier may correspond to a translation for at least a portion of the message. Sometimes, the portion of the message is the full message (562). For example, where the entire message was mapped, the translation may cover the entire phrase. Such a technique may be used, for example, where there is a limited number of potential phrases and speed is important. It may also be done, for example, where the condition(s) resulted in different translations for the entire phrases, as opposed to just a portion of the message. In some embodiments, only a portion (such as a word or two) of the message will be mapped.

The client 200 compares (564) the value of the condition to the identifier. For example, if the condition was gender, client would compare a value (e.g., male) to see which tuple for a given language and portion of a message corresponded to “male.” If the value does not match, another tuple will compared. The process will continue until a match is found. When the value of the condition matches the identifier, the client 200 retrieves (566) the translation corresponding to the identifier from the file. In the event that no tuple contains a match for the portion of the message, language, and condition, the translation will not be obtained from the file. In such a situation, client 200 may use a translation database, as described previously with respect to steps 542, 544, 546, 548, 550, and 552.

In some embodiments, the selected translation is displayed (568) to user 106. For example, social media application 226 on client 200 may display the message on screen 240 (FIG. 2) in a text box or on a pop-up window.

Although some of various drawings illustrate a number of logical stages in a particular order, stages which are not order dependent may be reordered and other stages may be combined or broken out. Furthermore, in some implementations, some stages may be performed in parallel and/or simultaneously with other stages. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software, or any combination thereof.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

1. A method, comprising:
at a client device having one or more processors and memory storing instructions for execution by the one or more processors:
in a social media platform of a social media service:
receiving a request to display a message to a user of the client device, wherein the user has a social media profile with the social media service;
determining a language in which to display the message, wherein the language has multiple translations for the message based on a condition associated with the user;
determining a value for the condition using information from the social media profile of the user;
selecting a translation from the multiple translations based, at least in part, on the value; and
displaying the selected translation to the user.

2. The method of claim 1, wherein:
the condition is a gender of the user; and
determining the value for the condition using the information from the social media profile of the user comprises obtaining the gender of the user from the social media profile of the user.

3. (canceled)

4. The method of claim 2, wherein
obtaining the gender comprises retrieving the gender from the social media service.

5. The method of claim 2, wherein:
the gender is other than male or female; and
the translation is selected based on the gender being other than male or female.

6. The method of claim 2, wherein:
the client device does not know the gender; and
the translation is selected based on the gender not being known.

7. The method of claim 1, wherein selecting the translation comprises:
transmitting at least a portion of the message, the language, and the condition to a translation database; and
causing the translation database to map at least the portion of the message to a phrase in the translation database based, at least in part, on the language and the condition; wherein the translation is the phrase.

8. The method of claim 7, wherein the at least the portion of the message is the message.

9. The method of claim 7, wherein selecting the translation comprises transmitting the value for the condition to the translation database.

10. The method of claim 1, wherein selecting the translation comprises:
opening a file, wherein the file contains mappings of phrases to translations of the phrases;
retrieving an identifier from the file, wherein the identifier corresponds to a translation for at least a portion of the message;
comparing the value of the condition to the identifier, and
when the value of the condition matches the identifier, retrieving the translation corresponding to the identifier from the file.

11. The method of claim 10, wherein the file comprises a spreadsheet.

12. The method of claim 10, wherein the file comprises a table.

13. The method of claim 10, wherein the file is loaded on the client device based, at least in part, on the language.

14. The method of claim 1, further comprising overriding an operating system function to retrieve the translation for at least a portion of the message.

15. The method of claim 14, wherein the client device is an Android device and the operating system function is an Android translation function.

16. The method of claim 15, wherein the Android translation function is getString.

17. The method of claim 1, wherein a quantity of the multiple translations is at least three.

18. The method of claim 1, wherein the request comprises a function call within the client device.

19. A non-transitory computer-readable storage medium storing one or more programs for execution by one or more processors of a client device, the one or more programs including instructions for:
in a social media platform of a social media service:
receiving a request to display a message to a user of the client device, wherein the user has a social media profile with the social media service;
determining a language in which to display the message, wherein the language has multiple translations for the message based on a condition associated with the user;
determining a value for the condition using information from the social media profile of the user;
selecting a translation from the multiple translations based, at least in part, on the value; and
displaying the selected translation to the user.

20. A client device, comprising:
a processor; and
memory storing one or more programs for execution by the processor, the one or more programs including instructions for:
in a social media platform of a social media service:
receiving a request to display a message to a user of the client device, wherein the user has a social media profile with the social media service;
determining a language in which to display the message, wherein the language has multiple translations for the message based on a condition associated with the user;
determining a value for the condition using information from the social media profile of the user;
selecting a translation from the multiple translations based, at least in part, on the value; and
displaying the selected translation to the user.

21. The method of claim 1, wherein:
the condition is an age of the user; and
determining the value for the condition using the information from the social media profile of the user comprises obtaining the age of the user from the social media profile of the user.
